(19) United States
(12) Patent Application Publication
(10) Pub. No.: US 2013/0019703 A1
(43) Pub. Date: Jan. 24, 2013

(54) MULTI AXIS MANOEUVRABLE PLATFORM

(71) Applicant: Steven Corcoran, Cawood (GB)

(72) Inventor: Steven Corcoran, Cawood (GB)

(73) Assignee: CORCOST LIMITED, Selby, North Yorkshire (GB)

(21) Appl. No.: 13/638,777

(22) PCT Filed: Aug. 12, 2010
(86) PCT No.: PCT/GB2010/001542

§ 371 Date: Oct. 1, 2012

(30) Foreign Application Priority Data
Mar. 31, 2010 (GB) 1005491.4
Apr. 6, 2010 (GB) 1005692.7

(51) Int. Cl. F16H 37/14; F16H 25/14

(52) U.S. Cl. 74/55

(57) ABSTRACT

A manoeuvrable platform comprising a planar base manoeuvrable by at least one cam operated lifting sub system positioned in relation to a back surface of the base, the or each lifting sub system comprising a cam blade arranged in a plane substantially parallel to that of the planar base section and operably connected to a cam drive in a casing, a first linear actuator operably connected to the cam drive casing and configured to provide linear displacement along a first axis, a second linear actuator operably connected to the cam drive casing and configured to provide linear displacement along a second axis and a pivoting means arranged for rotating the planar base.

The present invention relates to manoeuvrable platforms and a mechanism for facilitating tilting of a platform about multiple axes.

### BACKGROUND TO INVENTION

Many systems have been proposed with regards to multi-axis surface movement. The requirement for multi-axis surface movement spans many industrial sectors, however the prior art in this area has struggled to address five basic issues; a limited movement envelope, a requirement for sequencing, achievement of safe and controllable multi-axis movement, minimising power consumption and space.

Traditionally combinations of linear actuators have been used for multi-axis surface movement. One example is demonstrated in US Patent Publication 2009269724 of Thomas wherein the movement of a platform is achieved as a function of linear input from linear actuators positioned around a centre pivot.

With regards to limited movement envelope and sequencing, Thomas's arrangement is such that a first linear actuator at its maximum movement has to be retracted in order that a second linear actuator is able to operate and as such, certain positions of the surface are only achieved after retraction of the first linear actuator to allow other linear actuators to complete their required movements for the desired platform manoeuvre. Thus, Thomas's arrangement requires a sequenced activation of the linear actuators to obtain certain platform manoeuvres and it is apparent the functionality of Thomas's mechanism can only be exploited with a limited movement envelope. Furthermore, it will be appreciated that Thomas's arrangement is not capable of a purely vertical lift.

With systems such as that of Thomas, safety issues can arise with sequencing and the resultant movement envelope. If movement from one extreme to another is attempted quickly, such sequenced systems could lock at a potentially extreme angle. This carries a risk that an operator may become trapped or suffer injury. Large power consumption is required to perform the sequence and allow the platform to move quickly, furthermore the linear actuators must be sufficiently geared and cooled as they will generate a lot of heat. The arrangement consumes space where the linear actuators are approximately the same length for any given stroke and as such the platform surface cannot be lowered below the base length of the linear actuators.

A further more complex example of the prior art is disclosed in WO9216923 of Murray wherein motion is achieved through two sets of linear actuators. The same issues encountered by Thomas are also encountered by Murray. The arrangement operates within a sequence and overall envelope as described for Thomas.

The present invention seeks to provide a mechanism for manoeuvring a platform that dispenses with a need to sequence actuator movement and achieves optimum operational capability within a less constrained movement envelope.

In accordance with the present invention there is provided a manoeuvrable platform comprising a planar base manoeuvrable by at least one cam operated lifting sub system positioned in relation to a back surface of the base, the or each lifting sub system comprising a cam blade arranged in a plane substantially parallel to that of the planar base section and operably connected to a cam drive in a casing, a first linear actuator operably connected to the cam drive casing and configured to provide linear displacement along a first axis, a second linear actuator operably connected to the cam drive casing and configured to provide linear displacement along a second axis and a pivoting means arranged for rotating the planar base.

Desirably there are multiple cam operated lifting subsystems arranged around the rotary actuator. In a preferred embodiment there are four subsystems arranged around the pivoting means which comprises a rotary actuator. In an option, the subsystems are arranged substantially symmetrically about the pivoting means but non symmetrical arrangements may be used to best suit a specific end use of the platform.

A rotary actuator pivoting means may comprise any mechanism capable of imparting rotation to the platform. Embodiments of preferred arrangements are described herein.

Referring to the first and second linear actuator, the first axis and second axis are desirably (but not essentially) substantially orthogonal to each other.

The sub systems and/or pivoting means are desirably secured to the platform. Preferably all are secured to the back surface of the platform and optionally are provided as an integral part of the platform.

The cam operated subsystems, pivoting means and linear actuators may take any of a range of forms, some of which are known from the prior art. Preferred embodiments of the components are described herein.

In one preferred option, the cam operated subsystem has the following construction; a cam blade in a rotationally mounted arrangement with a cam shaft, the cam shaft bearing a circumferentially arranged toothed section meshing with a toothed section of a toothed rack whereby linear motion of the toothed rack in either one of two opposite directions translates to rotary motion of the cam shaft in one of two opposite directions dictated by the direction of linear motion of the toothed rack, the toothed rack extending from a threaded nut, the axis of the nut arranged in parallel with the linear axis of the toothed section, the nut meshing with a complementary thread of a leadscrew which is rotationally mounted but constrained from linear motion and a drive for driving the leadscrew to rotate in either one of two opposite directions and thereby bring about linear motion of the toothed rack, an extension shaft associated with the cam blade and a guide track incorporating a guide channel in which, during operation, the extension shaft is caused to travel whereby to adjust the separation between the cam blade and the back surface of the platform.

The connection between the extension shaft and cam blade desirably includes a multi axis joint. Desirably, the extension shaft is rotatably mounted with respect the cam blade plane. Optionally, the rotatable mount is a roller which is arranged to interact with one or more additional rollers provided in the cam blade.

The toothed rack may, optionally extend linearly to operably engage with a second gear rotatably mounted on a separate shaft in parallel axial alignment with the cam shaft.

In any subsystem, the linear actuator may incorporate a resilient biasing means which serves to assist linear motion of the piston in one of the two directions. The resilient biasing means Optionally comprises a spring which is under tension when the piston is retracted and tends to urge the piston to travel so as to extend.

Resilient biasing means may be provided at one or both ends of the piston. In one option, the resilient biasing means is enclosed in the casing by the piston.

Optionally at a free end of the casing of the linear actuator there is provided an attachment aperture. Conveniently the aperture receives the cam shaft which is rotatably mounted therein. The attachment aperture may form part of an attachment element which is rotatably mounted about the end of the linear actuator casing. The cam shaft and attachment element are conveniently rotatably mounted about two orthogonal axes.

At an opposite end of the linear actuator, the emerging piston may terminate in a roller. Optionally the emerging piston may include an annular collar against which a resiliently biasing means can be compressed.

The linear actuator may optionally be pneumatically or hydraulically controlled and may incorporate one or more valves in its casing for controlling the speed of passage of fluid into and/or out of the chamber. The one or more valves may be one way valves or two way valves. The chamber may be divided into multiple chambers each of which optionally incorporates a valve.

In one embodiment, the platform comprises a first wall and a second wall sandwiching an operating section which houses the subsystems and rotary actuator. The operating section is divided into three sub sections, two outer sections housing the subsystems and an inner section housing the rotary actuator. The guide track of the cams is embodied in the first wall. The pivoting in this embodiment comprises a pivotally mounted movement element operably connected with first and second walled lugs, the first lug connecting with the first wall and second lug with the second wall. The at least pivotally connected element lock may conveniently comprise a telescopic component able to extend and retract as the separation of the walls changes under action of the subsystems. For example, the telescopic component is a fluid based cylinder such as a pneumatic or hydraulic cylinder. The pivotally connected element lock is pivotally attached in at least one axis to each walled lug. This pivotal attachment might be achieved, for example, via a multi axis joint which might, for instance, comprise a rose bearing, which allows the element lock to rotate both axially and radially about its connection with the respective walled lug.

In alternative embodiment a plurality of subsystems is sandwiched between a first and second wall, a guide track of the cams is embodied in each of the first and second walls. The subsystems are oriented in a plurality of different orientations, for example four subsystems may be oriented in four mutually orthogonal orientations. The pivoting means is embodied in one or more the subsystems incorporating a pivotal joint. Each subsystem incorporates one or more locking elements. The locking elements desirably comprise four in number, two of which are desirably positioned adjacent the first wall (the upper set) and two adjacent the second wall (the lower set). The locking elements each engage lugs provided on the adjacent wall.

In alternative embodiment a plurality of subsystems is sandwiched between a first and second wall, a guide track of the cams is embodied in each of the first and second walls. The subsystems are oriented in a plurality of different orientations and are collectively linked together to form a cam chassis. The pivoting means is embodied in one or more the subsystems incorporating a pivotal joint.

Preferably when incorporated, the rotary actuator is a self contained unit comprising an actuator operable to rotate a leadscrew in one of two opposite directions dictated by the direction of rotation of the actuator, the leadscrew carrying a nut, the nut carrying a toothed rack extending in parallel with the axis of the leadscrew, the toothed rack engaging with a first gear mounted on a shaft arranged orthogonally to the leadscrew and toothed rack, a second gear of larger diameter than the first gear and mounted concentrically with the first gear and a sprung element separating the first and second gears, the second gear meshes with a third which in turn meshes with a fourth which is mounted on and rotates an exit shaft in a one of two opposite directions determined by the direction of rotation of the actuator.

The sprung element optionally comprises a pair of concentric rings and one or more resiliently biased tines connecting the rings.

The fourth gear optionally is attached to a casing of the leadscrew by resiliently biased means. For example, the resiliently biased means is a spring having one end connected to each of the casing and the gear.

The toothed section is optionally disengageable from the first gear permitting the second gear to rotate freely. Disengagement may optionally be achieved by operably connecting the toothed rack to an external actuator arranged to lift the toothed rack away from the first. For example this may be accomplished by incorporation of a bar which shares a casing with the toothed rack and which is independently movable by means of an external actuator, such that movement of the bar is transmitted to the toothed rack via the shared casing.

The exit shaft may be extended and operably engaged with a second rotary actuator. For example, but without limitation, the second rotary actuator may be a manually operated handle or an electrically operated motor.

Alternatively the extended output shaft may be used to attach one or more additional cam operated subsystems as previously described. Where multiple subsystems are so connected they are herein termed “cam nests”. Attachment may be via the optionally rotationally mounted attachment apertures previously described.

In another embodiment, therefore, the platform may incorporate a plurality of cam nests arranged in a plurality of orientations.

The cam nests are desirably paired such that each in the pair counter rotates with respect to the other cam in the pair.

In another option, the platform comprises a first wall and a second wall sandwiching an operating section which houses the subsystems and pivoting means. Each subsystem is arranged for free movement respective to the profile of the at least one cam or cam nest, the rotational direction of the at least one cam or cam nest and the load placed on the at least one cam or cam nest.

Optionally, a subsystem operably connects at two ends with each of the first and second walls, each end is pivotally connected with respect to a shaft on which is mounted a roller which in turn engages a guide track provided in each of the first and second wall and also with respect to which is pivotally mounted a slider means which includes a guide which is pivotally connected to the respective first or second wall and one of the shafts incorporates a pivot joint between the mounted roller and pivotal connection with the subsystem.

Optionally any subsystem may incorporate a locking element. Optionally the locking element is comprised as follows;

a casing incorporates a slot in parallel with the axis of a leadscrew rotatably mounted in the casing, a nut threadably engaged with the leadscrew and including a radially outwardly extending protrusion which is received in the slot whereby to prevent the nut from rotating with the leadscrew and a motor for driving the leadscrew in rotation whereby to bring about relative axial movement between the nut and the leadscrew.

The slotted casing is optionally enclosed by a cover preventing the ingress of alien particles.

By way of example, some embodiments of the invention and of novel component parts suitable for use in embodiments of the invention will now be described with reference to the accompanying Figures in which;

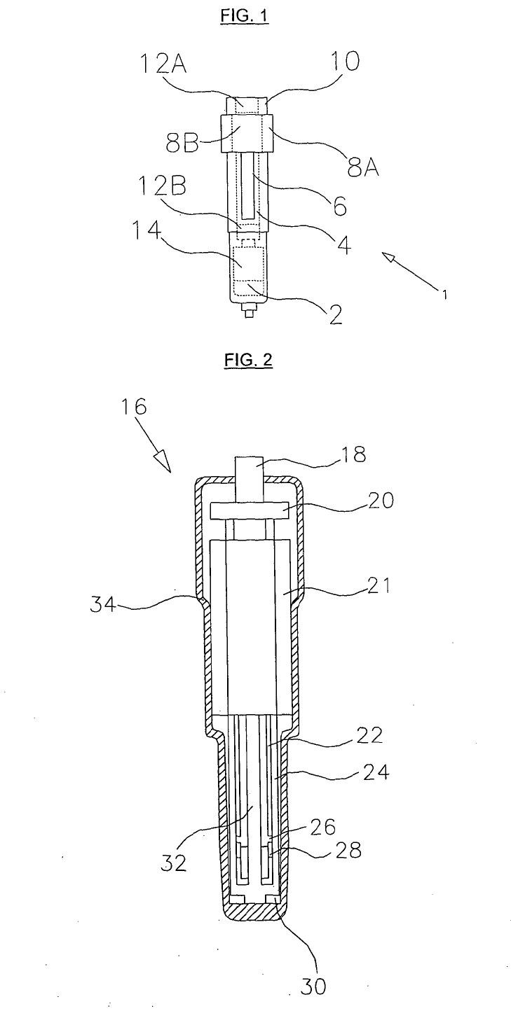

FIG. 1; shows a plan view of an embodiment of a locking element for use in embodiments of the invention

FIG. 2; shows a side section view of a linear actuator for use in embodiments of the invention

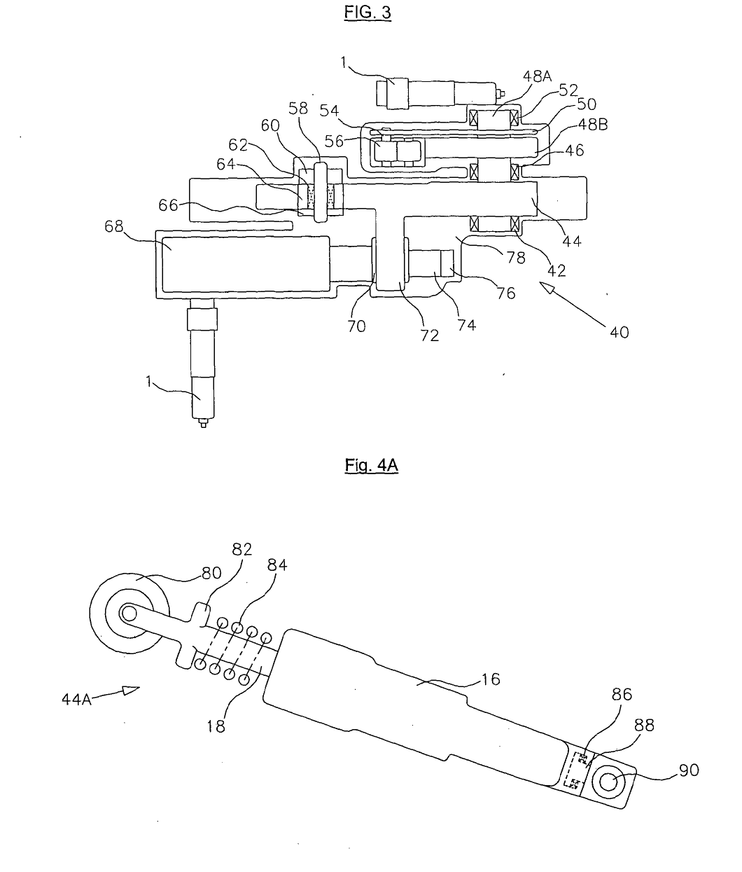

FIG. 3; shows a plan view of a cam operated subsystem for use in embodiments of the invention

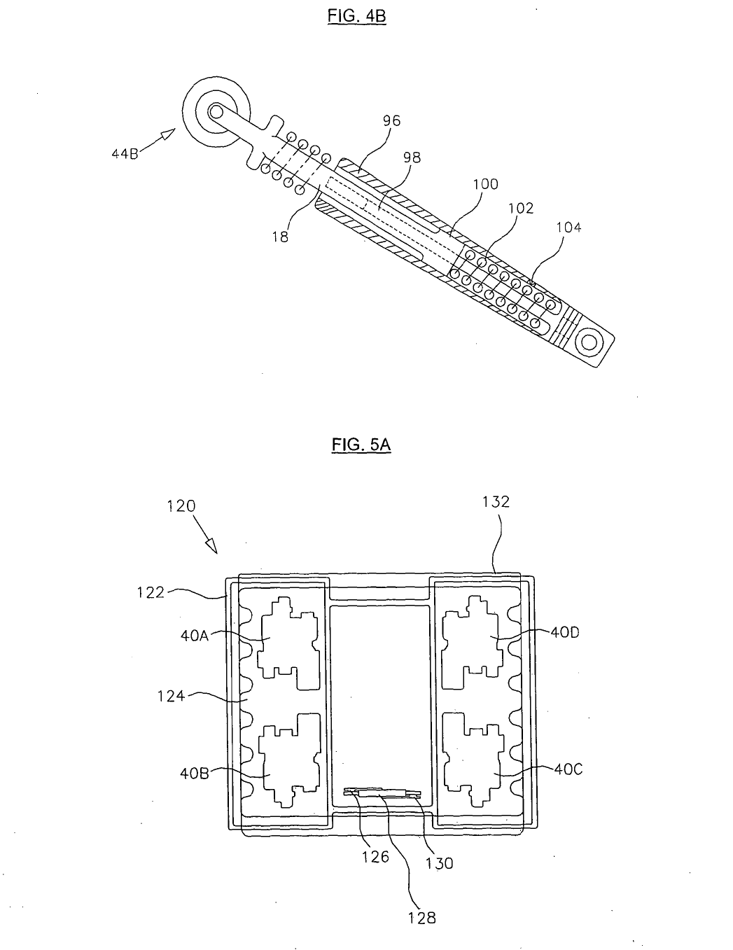

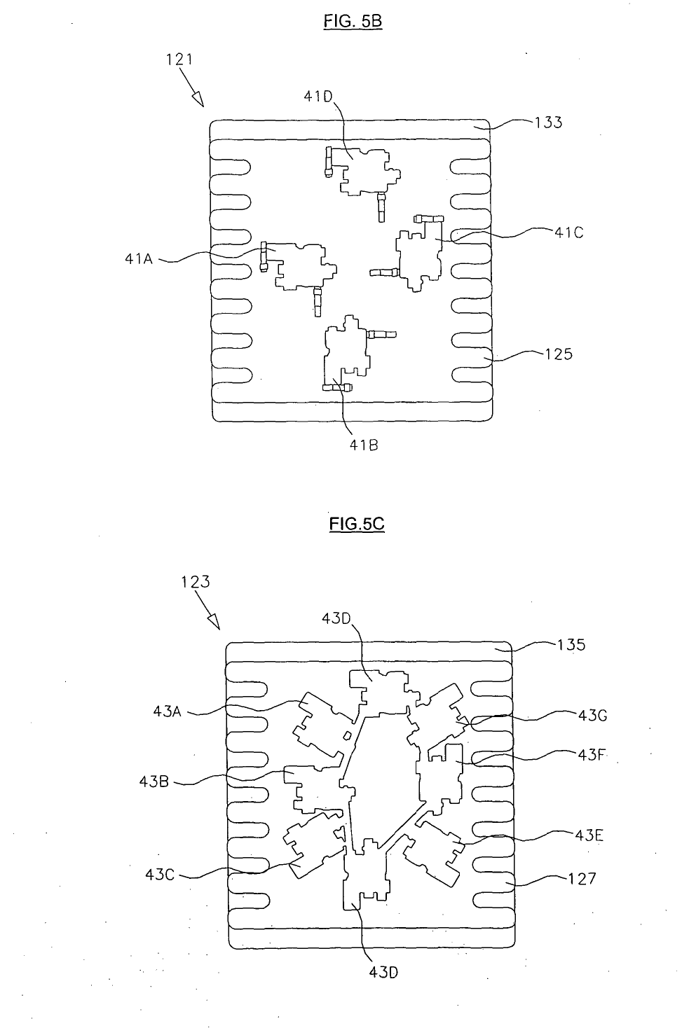

FIG. 4A; shows a side view of a cam operated subsystem for use in embodiments of the invention

FIG. 4B; shows a side section view of a cam operated subsystem for use in embodiments of the invention

FIG. 5A; shows a plan view of a first embodiment of a platform in accordance with the invention

FIG. 5B; shows a plan view of a second embodiment of a platform in accordance with the invention

FIG. 5C; shows a plan view of a third embodiment of a platform in accordance with the invention

FIG. 6; shows a side section view of a gearbox for use in embodiments of the invention

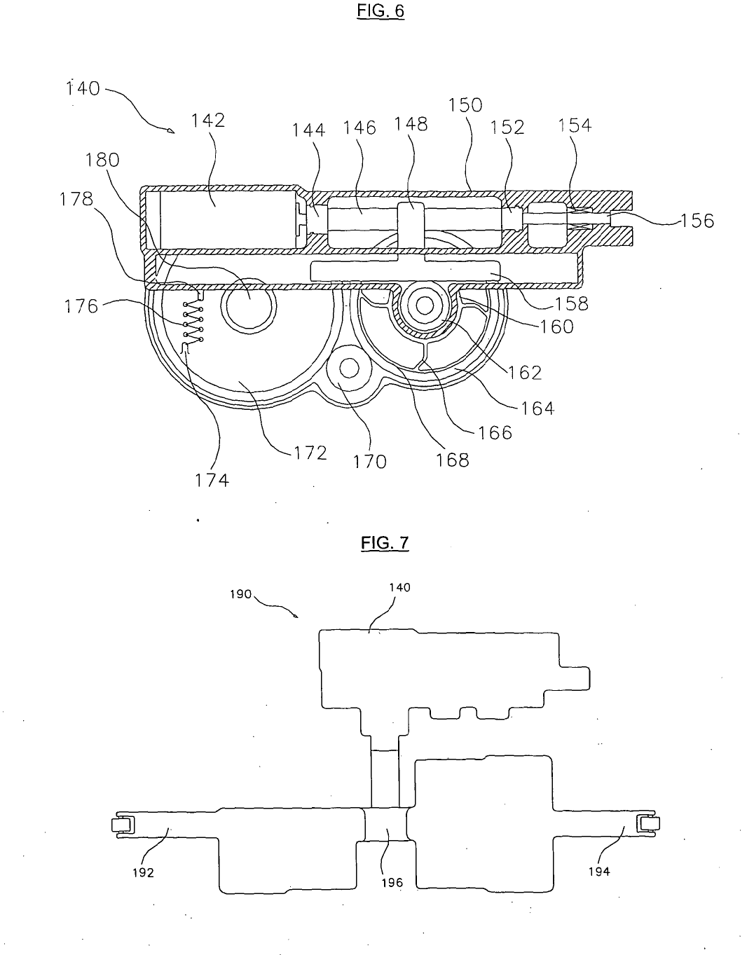

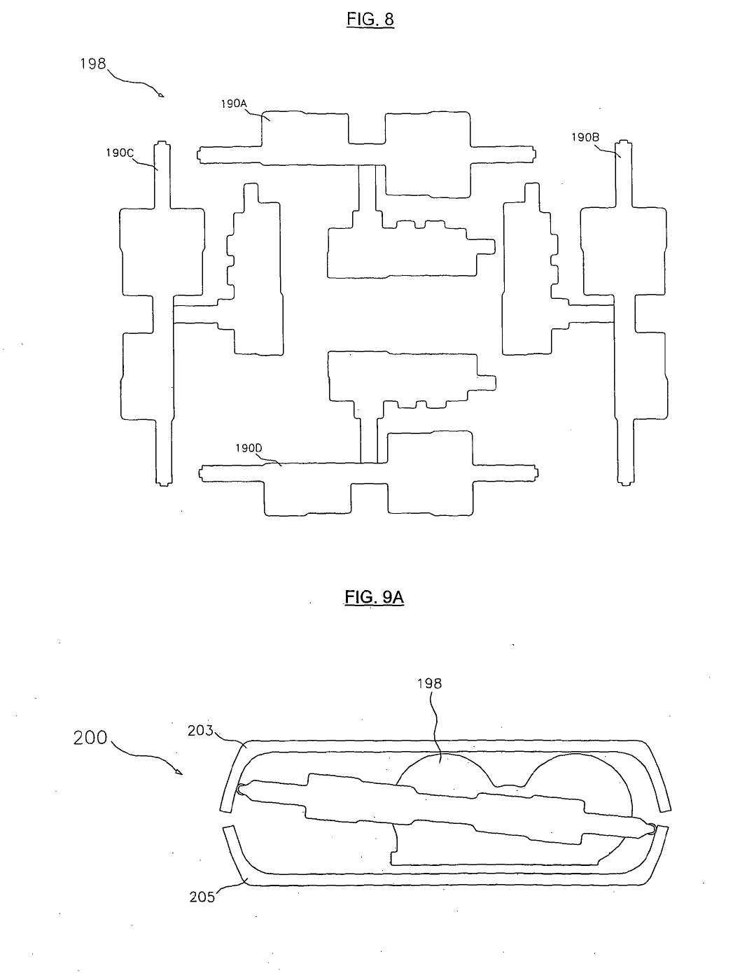

FIG. 7; shows a plan view of a floating axis subsystem for use in embodiments of the invention

FIG. 8; shows a plan view of a fourth embodiment of the invention

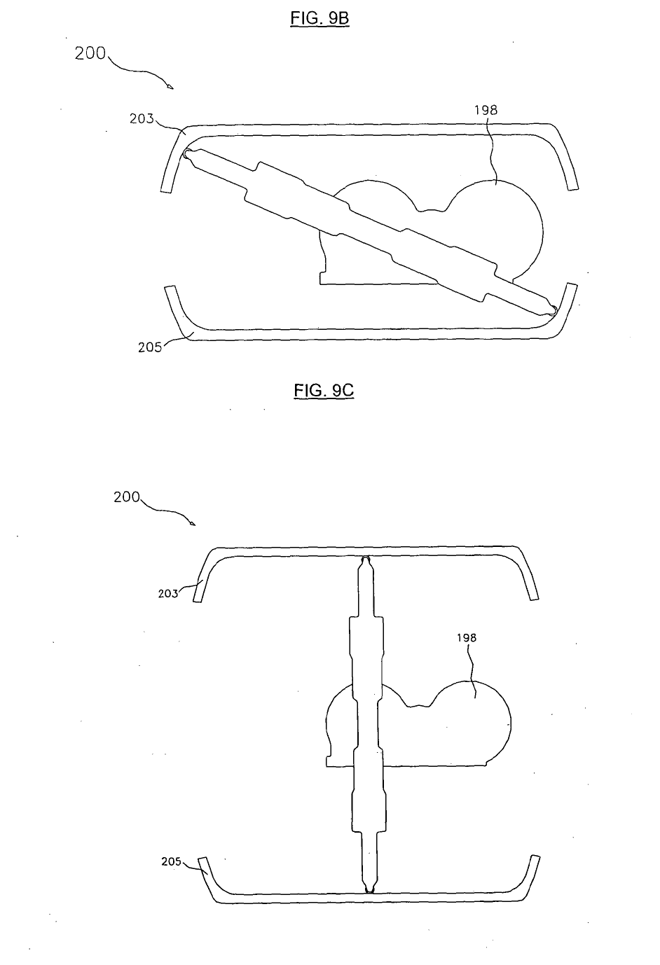

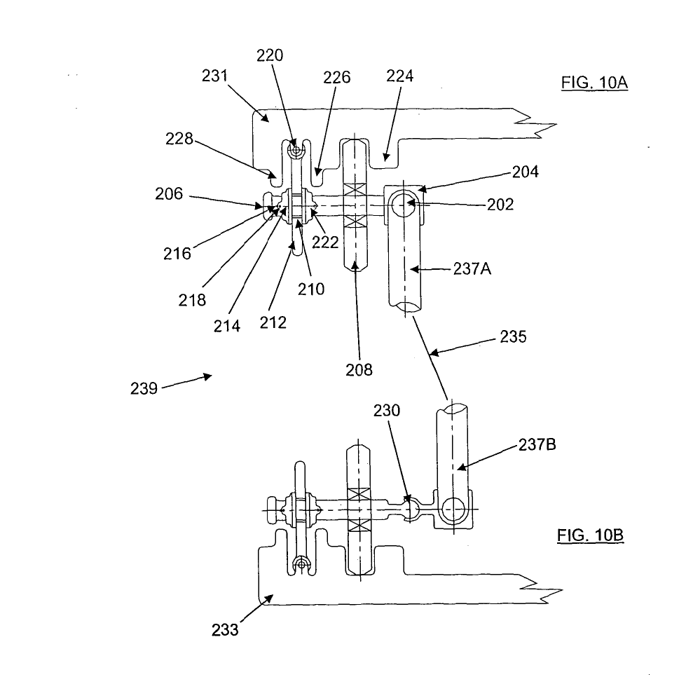

FIG. 9A; shows a side view of the cam nest referred to in FIG. 8 when the platform has been fully lowered

FIG. 9B; shows a side view of the cam nest referred to in FIG. 8 when the platform is partly raised

FIG. 9C; shows a side view of the cam nest referred to in FIG. 8 when the platform is fully raised

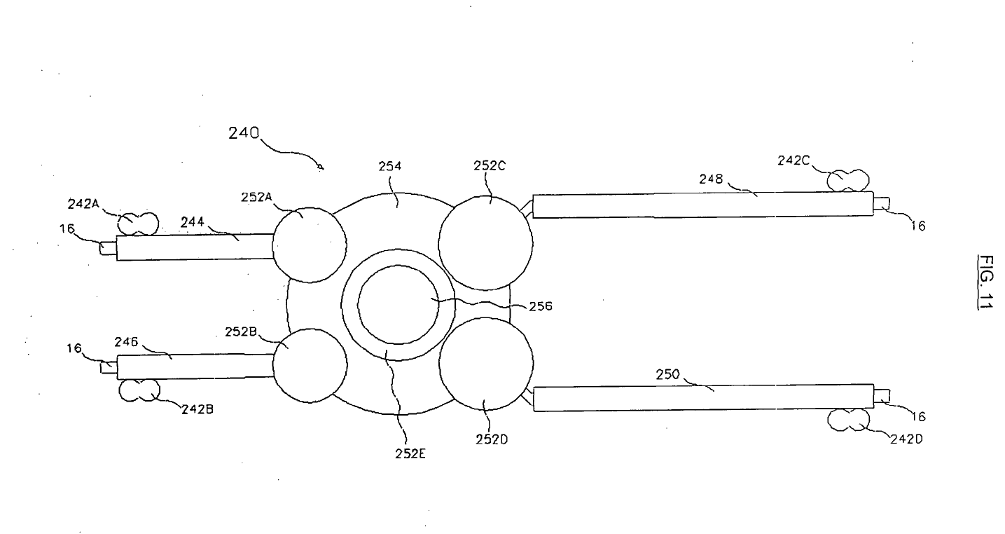

FIG. 10A; shows a front view of a subsystem to platform wall fixing for use in embodiments of the invention

FIG. 10B; shows a side front view of a subsystem to platform wall fixing for use in embodiments of the invention

FIG. 11; shows a plan view of a non specific embodiment of the invention.

### DESCRIPTION

The present invention optionally uses components described in other pending patent applications and patents of the applicant, specifically international patent applications numbers; PCT/GB2010/000261; PCT/GB2010/000250 and PCT/GB2010/000255, and international patent publication number WO2005018522. However, other suitable linear, rotary actuators or cam arrangements are able to be used where appropriate and as someone skilled in the art will understand. It is also clear that the present invention advances beyond any prior art and has clear inventive steps and as such the present invention advances the art.

FIG. 1 illustrates the locking element 1 which features a casing 10 which has a slot 6. The casing allows the correct retention of the at least one inner component. Typically the casing allows the retention of a leadscrew 4 which is held in the casing with bearings 12A and 12B where the bearings allow low friction rotation of the leadscrew 4. The leadscrew is meshed with the nut 8A which features at least one hole 8B and is also permanently or removably attached to a motor 14. The motor 14 is located within the cavity 2 within the casing 10. Therefore the rotation of the motor rotates the leadscrew and via the leadscrews meshed arrangement with the nut 8A the nut moves linearly along the axis of the leadscrew in the first or second direction depending on which direction the motor rotates.

The nut 8A typically has a portion within the casing 10 and a portion external to the casing whereby the portions are permanently or removably attached or integrated. Typically but not limited to the attachment or integration between the portions exits the casing via the slot 6 and as such the association between the portions attachment or integration with the slot prevents the nut 8A from rotating about the axis of the leadscrew. Typically but not limited to the relationship between the slot and the nut is able to feature lubrication and or a suitable bearing. Typically but not limited the slot will feature at least one cover to inhibit moisture or particulates, whereby the cover will allow the nut to move and cover the slot both in front and behind the nut. Typically two covers will be used with one located at the front of the nut and one behind the nut and typically in both cases one end of the cover will be permanently or removably attached or integrated to the nut or casing.

FIG. 2 illustrates a linear actuator 16. Any type of suitable linear actuator is able to be used in any embodiment herein, but and typically a variant of the one illustrated will be used. The illustrated linear actuator is a compact actuator and detailed in the Corcost linear actuator patent and, thus only a brief description is offered here.

The linear actuator 16 is able to feature its own case 34 or be incorporated into a frame. The linear actuator features a piston rod 18 which is meshed with a leadscrew 32 which is attached or integrated to the drive column 24. The piston typically but is not limited to having at least one protrusion 26 which typically but is not limited to engaging with the at least one slot 28 located in the at least one inner column 22. The drive column is located on at least one bearing 30. The linear actuator typically features at least one electric motor 21 although a manual actuator could also be used. The motor is attached to a gear 20 such that when the actuator 21 rotates, the gear 20 rotates. The gear 20 is meshed with a corresponding gear on the drive column and as such the drive column will rotate as a result of the motor 21 rotating.

The rotation of the drive column in turn rotates the leadscrew 32 and via its meshed arrangement with the piston 18, sees the piston move in the first and second direction depending on the rotational direction of the motor 21. The at least one protrusion 26 of the piston inhibits the pistons rotation and keeps the piston in the correct orientation via its relationship with the at least one slot.

It will be appreciated by someone skilled in the art that many other orientations of the at least one motor 21 with regards to the drive column and or leadscrew are acceptable and the final orientation as well as the number and location of motors will depend on the requirements of the application. For example, it will be appreciated that multiple motors are able to be positioned radially around the drive column and more towards one end than the other or generally central.

FIG. 3 illustrates the CAM section 40. The CAM section has a casing 78 which is able to retain the at least one internal component sufficiently during the internal components operation. Typically but not limited to the casing allows self containment of the components during operation or otherwise and as such is able to be termed a stressed member. Of course it will be appreciated that the casing geometry could be incorporated into another device and or frame and or other such item where the device and or frame or the like are able to perform the same function as the casing 78.

The casing is able to contain the CAM system, the CAM system showing at least one bearing and in this case but not limited to showing three bearings 42, 46 and 52 retaining a central CAM shaft 48A. Typically the CAM shaft is permanently or removably attached or integrated to the CAM 48B such that rotation of the CAM shaft rotates the CAM. The CAM is able to feature and support internal components. The CAM shaft typically has a toothed section permanently or removably attached or integrated and typically this is able to form a full or partial gear. The toothed section 44 is compatible with the CAM shaft toothed section to which it is meshed.

The toothed section is able to feature a tail section with a further toothed part, the toothed part is meshed with the gear 64, where the gear 64 is able to be located permanently or removably on at least one bearing 62 and or shaft 58 such that it is able to rotate with low friction and where the forces received by the gear are able to be transmitted to the casing via the shaft. The gear 64 is able to be integrated with the shaft 58. The toothed rack 44 further has an arm 72 whereby the arm is integrated or permanently and or removably attached to the nut 70. The nut 70 is meshed with the leadscrew 74 which is in turn held by at least one bearing 76.

The leadscrew is attached permanently or removably to an actuator 68 whereby the actuator is able to be an electric motor or a manually activated assembly. Typically and in this case the actuator is an electric motor.

The CAM 48B features at least one roller or bearing type element 56 the at least one roller or bearing type element is able to feature an extension shaft 54. Typically the extension shaft 54 is permanently or removably and or moveably attached to or integrated with the CAM and is able to feature an amount of flexibility respective to the desired operational parameters. Typically the extension shaft 54 is movable where the extension shaft 54 is able to feature a multi-axis or single axis connection with the CAM. Typically the at least one bearing or roller rotates around the axis of the extension shaft 54 or rotates with the shaft about the shaft axis. The extension shaft 54 is typically but not limited to engaged within a channel on the at least one guide track 50.

The channel in the guide track is typically (but not limited to) profiled and is able to be an open channel such that the extension shaft 54 is able to enter one side and exit the other if required or a semi-channel where the channel is closed and would be similar to a groove. Typically the at least one guide track 50 is permanently or removably attached or integrated to a first or second surface to form a first guide track and a second guide track respective to each surface.

The CAM system operates via the actuator 68 rotating in the first or second direction the rotary motion produced rotates the leadscrew in the corresponding direction and subsequently via the leadscrews meshed relationship to the nut 70 moves the nut 70 linearly along the axis of the leadscrew in the first or second direction. The nuts movement causes the arm 72 to move and subsequently the tooth rack 44, both of which move linearly and parallel to the axis of the leadscrew. The motion of the toothed rack 44 causes the gear 64 to rotate as well as the shaft 48A due to the meshed relationship the toothed rack has with each one.

As the shaft rotates in the respective first or second direction, so the CAM 48B rotates in either the first or second direction which typically corresponds to the CAM rotating in a clockwise or anti-clockwise direction. As the CAM rotates in either the first or second direction the at least one roller and or bearing which typically contacts a first or second surface will transit force and motion to that surface.

The extension shaft 54 will be engaged with the guide track 50, however, as will be appreciated if the CAM rotates in the first direction then the extension shaft 54 will engage with a first guide track and if the CAM rotates in the second direction the extension shaft 54 will engage with the second guide track. Typically and taking the CAM at the zero position where the CAM is in an equal position between the first and second direction, the channels in the first and second guide track will also be at the zero position and at that point they will form at least one harmonised channel profile which allows the extension shaft 54 to move between channels respective to the rotational direction of the CAM. Typically the at least one channel in the at least one first and or second guide track has an open end irrespective of whether or not the channel is an open channel or a closed channel.

The CAM 48B as described can feature at least one roller and or bearing on the first and or second side and as such the relationship between the at least one roller and or bearing and the at least one CAM shaft axis respective to CAM rotational direction will depict the profile of the CAM. It will be appreciated that where the CAM has multiple rollers and or bearings distributed on the CAM, as the CAM then rotates the relationship between the at least one roller and or bearing and the CAM shaft axis will to change and as such the CAM profile is able to change respective to its rotation. The CAM profile on the first and second side are able to be different or the same.

It will be appreciated that the at least one channel in the at least one first or second guide track is able to allow the at least one surface to be lifted away from the at least one CAM such that the at least one CAM and the at least one surface are no longer touching yet the shaft extension is still within the at least one channel and such that the at least one surface is not able to be removed from the overall CAM assembly.

The figure further illustrates at least one locking elements 1 which can be permanently or removably attached or integrated with the CAM casing. In some cases the CAM section does not require any locking elements. Typically the locking elements are integrated with the casing and typically but not limited to four locking elements are used.

The Figure only shows two locking elements however the two further locking elements are positioned directly underneath those shown. Typically the locking elements are used to retain the CAM section against at least one surface whereby the upper locking elements typically retain the CAM section to the first surface whilst the lower locking elements typically retain the CAM section to a second surface.

It will be appreciated by someone skilled in the art that the extension shaft is able variable in length whereby one part of the shaft is sprung loaded and where one part of the shaft is able to slide over another part of the shaft.

FIGS. 4A and 4B illustrate variable geometry CAMs 44A and 44B. The CAM 44 as previously discussed (see FIG. 3) is able to exhibit all the functions and features described herein for CAM 44A and 44B as the CAM 44A and 44B are able to not only exhibit all the functions and features of 44 but also each others. It will be clear to someone skilled in the art that this ability to apply any one and or all and or any combination of functions and features to either CAM 44, 44A or 44B allows for functions and features to be described just once and not repeated for each CAM herein.

With reference to FIG. 4A, the CAM 44A illustrates the ability to feature a linear actuator 16 (see FIG. 2) within the CAM. The linear actuator is able to extend and retract and thus alter the CAM profile at any point through the rotation of the CAM in either the first or second direction or whilst the CAM is at rest. Typically the CAM 44A features at least one roller and or bearing 80 which is movably attached to the CAM via a bearings or other low friction rotational elements. Typically the at least one roller or bearing is attached moveably to the piston 18 of the linear actuator (see FIG. 2) and further still the piston of the linear actuator may feature an increased diameter section or collar 82 which can be permanently or removably attached or integrated with the piston 18. At least one spring 84 is able to be located between the collar and the CAM or the body of the linear actuator.

The spring is typically but not limited is compressed when the piston is in the first non-extended position where the collar is towards the body of the linear actuator.

The linear actuator is able to extend the piston in the first direction to the pistons second position whereby the piston extends away from the body and whereby the spring is then able to uncompressing and impart force upon the collar. The uncompressing of the spring reduces the force required by the linear actuator to extend the piston.

When the linear actuator retracts the piston moves in the second direction, the spring compresses, however the spring compresses as a function of the load present on the end of the CAM and typically the load which is placed on the roller and or bearing 80. In this way the spring serves as an energy storage and power reduction device as a function of loadings placed upon it and its movement.

The CAM 44A is able to feature shaft attachment hole 90, the CAM being able to be removably or permanently attached to or integrated with a CAM shaft such as 48A from FIG. 3. Further still the CAM features at least one further axis of rotation via the integral pivot section. The CAM typically features two sections moveably joined whereby the first section features a mushroom shaft 88 that locates in the second section with a bearing 86 such that the second section is able to rotate about the axis of the mushroom shaft 88 and typically perpendicular to the CAM shaft axis.

FIG. 4B illustrates the CAM 44B, the unit as has been described is able to exhibit all the features and functions of 44A and 44 and thus any items which is the same will not be described. The CAM makes use of the piston 18 in a different manner to FIG. 4A. In this case the piston is able to feature the spring between the body 96 and the collar termed the first spring as FIG. 4A, however, the piston is also able to feature at least one other spring termed the second spring. This second spring 102 is added internally to the CAM between at least one inner surface of the CAM body 96 and the piston head 100.

The at least one second spring typically locates around the axis of the internal rod 98, the internal rod being permanently or removably attached to or integrated with the CAM body 96.

The internal rod 98 locates within the piston 18 such that the piston movably receives the rod, typically the piston slides over the top of the rod. As the piston and therefore the piston head moves in the first direction the at least one spring will uncompress, thus the first and at least one second spring will uncompress and assist in the movement of the piston and piston head in the first direction. However in the second direction and as force increases on the at least one roller and or bearing, the at least one spring will be compressed. The first and second springs are able to feature different compression and expansion properties and characteristics or the same such properties and characteristics and as such the first and second movements of the piston are able to operate respective to different loads and speeds.

The CAM typically but not limited to features at least one valve 104, the valve being a one or two way valve. The valve works with compressible or uncompressible fluid. Typically the valve is a pneumatic valve with respect to compressible fluid. The at least one valve is located in the first half of the CAM respective to the first chamber housing the at least one second spring 102 at the first side of the piston head 100.

Fluid is able to be contained the first chambers and as such any movement respective to the piston in the first or second direction is able to be controlled in terms of both speed and retraction time respective to the at least one valves properties and characteristics. The at least one spring and the at least one valve are able to be harmonised respective to each other and to the required operational parameters of the piston and CAM in their respective first and second directions. Unlike the at least one first or second spring which remain proportional to load, the valve offers the ability to vary the pistons movement and therefore the CAMs profile based upon the magnitude and speed at which a load is applied to the CAM. This means that the CAM piston and therefore the CAM profile is able to alter disproportionally with respect to the load being applied in terms of its application speed and magnitude.

We are able to state that the at least one valve allows the rate of change of the CAM piston and therefore the CAM profile to be varied with respect to load and load speed. This enables a two part CAM geometric alteration, the springs are able to give a constant and proportional response to the speed at which a magnitude of load is applied to the CAM whereas the valve is able to deliver a disproportional response to the speed at which a magnitude of load is applied and all respective to piston movement in the first and or second direction and therefore respective to the at least one CAMs length and therefore the at least one CAMs profile.

It will be appreciated to the someone skilled in the art that valves are able to be placed in the second and third chamber of the CAM where the second chamber is at the second side of the piston head 100 and the third chamber is the space required for the operation of the rod 98 respective the piston 18 and sees a valve fitted to the actual piston itself. The second and third valves respective to the second and third chambers operate in the same manner as the first valve where all valves are able to be operationally harmonised or operationally independent of each other.

FIG. 5A illustrates the first embodiment 120 which features at least one CAM section 40. In this first embodiment four CAM sections 40A, 40B, 40C and 40D are used where each of the illustrated CAM sections is able to have all the same functions and features as described for the CAM section 40 in FIG. 3.

Furthermore the at least one CAM featured in the at least one CAM section 40A, 40B, 40C and 40D are able to have all the same functions and features as described with respect to CAM 44, CAM 44A and CAM 44B from FIGS. 3, 4A and 4B.

The first embodiment includes a first surface 124 which is located generally above the second surface 132. Between the surfaces is located a bellows element 122 and the at least one CAM section. The bellows element allows the respective movement of the surfaces yet encases the at least one CAM section. In this case the bellows element has three distinct sections, the first section encases CAM sections 40A and 40B, the second section encases CAM sections 40C and 40D and the third section of the bellows element encases the at least one geometrically variable pivotally connected movement lock 128 and associated components 126 and 130.

Each CAM section typically has its own at least one guide track 50 (see FIG. 3) and channel. This first guide track is permanently or removably attached or integrated with the first surface 124. The at least one CAM of the respective CAM section engages with the channel of the respective first guide track via its extension shaft and engages with the second side of the first surface via its at least one bearing and or roller. Therefore as the CAMs rotates in the first or second direction the bearings and or rollers transfer force and or motion to the first surface and as such the first surface will move with respect to the at least one CAMs profile and rotational motion. The CAM sections in this embodiment do not feature the locking elements 1 as in this embodiment the CAM sections are permanently or removably attached or integrated to the second surface 132. Typically but not limited to at least one pivotally connected movement element lock 128 and associated components are situated between the first and second surface. The element lock 128 is connected permanently or removably or moveably to the first walled lug 126 and the second walled lug 130 where 126 is permanently or removably attached or integrated with the first surface and 130 is permanently or removably attached to the second surface.

The at least one pivotally connected element lock 128 is a telescopic component but which is able to extend and retract with the respective movement between the surfaces. Typically the telescopic component is a fluid based cylinder such as a pneumatic or hydraulic cylinder type arrangement. The pivotally connected element lock is pivotally attached in at least one axis to each walled lug. The attachment is typically via a rose bearing type joint that allows the element lock 128 to both rotate axially and radially around the connection with the respective walled lug.

The first surface is able to be sub-divided into reference corners and edges, the first edge being the rear edge, the second edge being the front edge, the third edge being the right hand side edge and the fourth edge being the left hand side edge. Respective to the corners, the first corner connects edge one and four, the second corner connects edge one and three, the third corner connects edge three and four and the fourth corner connects edge two and three.

Where the CAM sections 40A and 40D operate and rotate their CAMs in the first direction the first edge and corners one and two lift, where the CAM sections 40B and 40C rotate their CAMs in the first direction the second edge and corners three and four lift, where the CAM sections 40A and 40B operate and rotate their CAMs in the first direction the fourth edge and corners one and three will lift and where the CAM sections 40D and 40C operate their CAMs in the first direction the third edge and corners two and four will lift. As will be appreciate all the CAMs are able to be operate independently or simultaneously at the same or different speeds and in the same or different directions and as such the first surface is able to exhibit many different combinations of movement.

Where the CAMs in the CAM sections operate independently the corners are able to be used to express the first surfaces motion. The operation of 40A independently in the first direction would lift the first corner of the first surface to that desired or with respect to the flexural properties and characteristics of the first surface. This is the same for the second, third and fourth corners with respect to the corresponding CAM sections. As an example, the second corner CAM section 40D would be operated in the first direction and lift the second corner as the CAM section 40B would lift the third corner and CAM section 40C would lift the fourth respective to flexibility of the first surface and the position and movement of the other at least one CAM.

If all four CAM sections rotate their respective CAMs simultaneously and at the same speed in the first direction, the first surface will be lifted vertically and each edge and corner will be raised at the same time to keep the surface level. The pure vertical lowering is able to be completed via the CAMs rotating in the second direction and if the CAMs rotate in the second direction at the same time then the surface will move in a level manner where all the edges and corners will maintain their respective level.

The vertical motion in either direction is able to be stopped or started at any point and combined with other CAM movements as described above and typically respective to the movement of the first surfaces corners. This enables the movement of the first surface such that at least one corner will be higher or lower or equal to at least one other corner via the operation of at least one CAM and by typically using at least one CAM as a pivot. Typically the movement in this case to raise one corner above another is completed by two CAMs moving in the first and second direction and pivoting the first surface about two other typically stationary CAMs or CAMs rotating at a different speed.

The CAM section of this embodiment is capable of producing complex motions of the first surface. One such example is where the first surface is lifted vertically level above the second surface resulting from all four CAMs rotation in the first direction at the same speed. At least two CAM sections for example, 40A and 40C rotate their respective CAMs in opposite directions such that first direction rotation from the CAM respective to section 40A and second direction rotation from the CAM respective to section 40C will move the first corner above all other corners whilst the fourth corner will be below the other corners. The CAM respective to the section 40C uses the connection with the guide track via the shaft extension to be able to transmit force and motion to the first surface and move the fourth corner downward and at the same time the CAM respective to the section 40A is using its roller and or bearings to transmit force and motion to the first surface and lift the first corner. The CAMs respective to the CAM sections 40B and 40D are therefore used by the first surface as live pivots points whereby the surface is pivoting about their CAMs.

The CAMs from section 40B and 40D are able to rotate and change the position of the first surface pivot point with respective to the above example. Moreover, if the CAMs from the sections 40B and 40D where to change there positions whilst the other CAMs were stationary, then by rotating in opposite directions where the section 40D CAM rotates in the first direction and the section 40B CAM rotates in the second direction the second corner of the first surface is able to be raised higher then another corner whilst the third corner of the surface is able to be lowered below any of the other corners and as such the CAMs respective to the sections 40A and 40C are utilised as live pivots.

During this motion anyone skilled in the art may realise it could present a desire for some longitudinal axial movement of the roller and or bearing with respect to the at least one CAM respective to the first surface. As has been previously referenced the CAMs 44, 44A and 44B are able to feature at least one axial pivot and as such any angular change between the guide track and or surface and the at least one CAM is able to addressed. Furthermore the extension shaft is also able to be pivotally connected to the CAM and or be of a flexible material such that the extension shaft is also able to address any angular change in the relationship respective to the guide channel.

Using the movement capabilities of the CAMs, the first surface is able to produce a motion termed a helix motion. The helix motion is where the first corner is raised above all other corners and typically the fourth corner is lower than all other corners, with the first edge being at an angle, the surface is than moved via the at least one CAM such that the first edge becomes level and as such the first and second corners at the same height and the fourth and third corners are typically at the same height.

The surface is then manipulated by the at least one CAM such that the second corner is higher than all other corners and the third corner is lower than all corners. Typically the surface is then manipulated via the at least one CAM such that the fourth and third corners and thus the third edge are level. It is then typical for the surface to be manipulated such the fourth corner is higher than all other corners and the first corner is lower than all other corners. The typical next stage is the first surface is manipulated such that the third surface is raised to be at the same height as the fourth surface and as such the second edge is level. The penultimate stage is the movement of the third corner whereby the corner is manipulated such that the third corner is above all other corners and the second corner is below all other corners and the final stage is the manipulation of the surface whereby the first corner and the third corner and as such the fourth edge are levelled and the next manipulation being the movement of the surface back to the beginning whereby the first corner is higher than the others with the fourth corner being the lowest.

It will be appreciated that the CAMs movement in the first or second direction is able to occur at any point throughout the helix motion to generate other motions. As has been described as well as the CAMs being able to move independently and simultaneously they are also able to move at different speeds simultaneously and as such the helix motion can be accomplished whilst the overall height of the first surface is changing, in that the first surface as well as moving in the helix motion as above is also able to additionally move towards and away from the second surface and as such the helix motion becomes a dynamic multi axis helix motion.

The CAM sections and therefore CAMs in the positions and orientations in which they are illustrated require at least one element 128 to assist in the first part of particular movements of the first surface. The element is typically orientated as shown, however it will be appreciated that several elements are able to be used and in different orientations if desired. The element 128 and walled lugs 126 and 130 provide additional characteristics to the movement of the first surface, an example is where the CAM sections 40A and 40D begin to rotate their CAMs in the first direction and lift the first edge. As such the first surface will want to pivot on the CAMs of the CAM sections 40B and 40C. If the CAM sections 40B and 40C and their respectively CAMs are generally at the lowest point with the CAMs fully rotated in the second direction or the zero point then this movement is typically acceptable. However, if the CAMs of the CAM sections 40B and 40C are not at the zero point, then the first surface is able yield an unwanted slide movement on the at least one bearing and or roller of the CAMs from each CAM section 40B and 40C.

This potential unwanted movement of the surface will exert movement on the element 126 which will manifest in the element trying to pivot about its connection with the second walled lug 130 and move towards the second edge of the first surface. This movement of the element will engage it with the walled section of the second walled lug 130 and also the walled section of the first walled lug 126. These engagements will lock the movement of the element 126 and as such lock the movement of the first surface with respect to at least one axis. As such and with the continued rotation of the CAMs in the CAM sections 40A and 400 the first surface will pivot about the CAMs of the sections 40B and 40C and therefore first surface will not slide or feature any unwanted movement. It will be appreciated that the if the CAMs from the sections inverted where 40B and 40C were to act as 40A and 40D and the latter acting as 40B and 40C element would still lock, however, its first engagement would be with the walled section of the first walled lug 126.

The telescopic nature of the element 128 means that the element is able to act in this manner irrespective of the distance between the first and second surface and as such the first surface with this orientation of CAM sections in has no sequences with respect to this movement type.

Where two elements 128 and the associated components 126 and 130 are used, the elements 128 may have the same features and characteristics, however, each is able to have different features characteristics such that different limits are able to be applied to the movement of the first surface.

As the above illustrates the surface is able to feature an almost infinite number of movement options with no sequencing, not only is the dynamic multi axis helix motion able to take place but the ability to translate the entire first surface in terms of height during the helix motion is a fundamental step change in first surface's movement capability over the prior art.

Additional to the above is the ability of the CAMs in the CAM sections in this embodiment to both pivot and extend via the usage of the CAMs detailed with respect to 44A and 44B in FIGS. 4A and 4B. As such not only is the first surface able to be manipulated via the rotation of the at least one CAM in the manner described above, the first surface is additionally able to be manipulated with respect to the varying geometry of the CAMs length and or profile as well as the magnitude and speed of the load applied to the CAM and also the position of the CAM with respect to the that loading.

FIG. 5B is the second embodiment 121 which is able to have all the same functions and features as the first embodiment 120 including the ability to produce a dynamic multi axis helix motion in at least one surface. However and unlike the first embodiment FIG. 5A this second embodiment is able to produce the dynamic multi axis helix motion in both the first and or second surfaces.

The CAM sections 41A, 41B, 41C and 41D are able to have all the same functions and features as the CAM sections 40A, 40B, 40C and 40D in the first embodiment and all the same functions and features as the CAM section 40 described in FIG. 3 and where the features and functions are the same they will not be described in detail as they have been described previously in the patent.

The first surface 125 is able to have all the same functions and features as any referenced first surface herein and the first surface 124 as described in the first embodiment. The second surface 133 is able to have all the same functions and features as any referenced second surface herein and the second surface 132 and as described in the first embodiment.

The at least one CAM in each CAM section 41A, 41b, 41C and 41D is able to have all the same functions and features as the CAM 44 from FIG. 3 as well as all the same functions and features of the CAMs 44A and 44B from FIGS. 4A and 4B respectively.

As is illustrated from the figure, the first surface 125 and second surface 133 are positioned such that the first surface is above the second surface. Typically between the surfaces is at least one CAM section. In this case CAM sections are located between the surfaces, namely, 41A, 41B, 41C and 41D with each CAM section able to be as described with relation to FIG. 3. As was described in FIG. 3, the CAM from each CAM section is able to rotate in the first or second direction and as also previously described, each CAM section will have at least one guide track 50 (see FIG. 3) which will engage with the extension shaft of the at least one CAM.

At least two guide tracks are present per CAM section, a first guide track and a second guide track. The first guide track is removably or permanently attached to or integrated with the first surface whereas the second guide track is permanently or removably attached to or integrated with the second surface. Each guide track has a at least one channel and the channel has an open end such that when the first and second surface are at their nearest or the zero surface point the open end of the first channel of the first guide track and the open end of the second channel of the second guide track are such that they form of one channel. The channels and therefore the guide track at this guide track zero point allows a component to move between the first and second channel.

The at least one CAM in each CAM section has a zero point termed the CAM zero point whereby the CAM is generally perpendicular to the axis of the CAM shaft. At this CAM zero point, the CAM extension shaft is situated such that when the surfaces and the guide tracks are at their respective zero points the extension shaft is located approximately equally in the first and second channel such that rotation of the CAM in the first direction will facilitate the extension shaft entering and engaging the first guide track whereas the rotation of the CAM in the second direction will facilitate the extension shaft entering and engaging the second channel of the second guide track. At the CAM zero point the extension shaft engages both the first and second channel of the first and second guide tracks when the guide tracks and thus the surfaces are also at their respective zero points.

The figure illustrates that the four CAM sections in this embodiment feature locking elements as referenced in FIG. 3. From FIG. 3 four locking elements are attached or integrated with each CAM section. The locking elements per CAM section are generally positioned with two near the top of the section and as such nearest to the underside of the first surface termed the upper set and two locking elements generally positioned near the bottom of the CAM section and thus positioned near the topside of the second surface termed the lower set.

Each surface has at least one surface lug permanently or removably attached or integrated and in this case each surface has at least two lugs per CAM section. With reference also to FIG. 1, each lug is aligned with hole 8B in the respective element such that when the nut 8A moves in the first or second direction respective to upper set or lower set the nut 8A via the hole 8B engages or disengages from the respective surface lug. It is typical that when the surfaces are at their zero point, the at least one CAM section is able to operate the upper set locking elements in the first direction to engage the first surface lugs and the lower set locking elements in the second direction to engage the second surface lugs and as such the CAM sections would be engaged and locked to both the first and second surface.

The movement of the first surface begins with the disengagement of the upper set locking elements from the first surface lug when the upper locking sets move in the second direction. The lower locking sets engaging the CAM sections with the second surface will remain engaged with the second surface lugs. The CAMs of the CAM sections typically but not limited to rotate in the first direction independently, simultaneously and at the same or different speeds and thus a dynamic multi axis helix motion of the first surface is typically achieved but not limited to that motion.

Irrespective to the relevant CAM positions, the CAMs then typically rotate in the second direction towards the CAM zero point. The first surface will move towards CAM sections and once at its nearest or surface zero point, the upper locking element set moves in the first direction and engages with the first surface lugs, whilst the lower locking element sets move in the second direction and disengages from the second surface lugs. At the surface zero point, the first and second guide track are at the guide track zero point where the CAMs extension shaft is able to move from the first guide track to the second guide track respective to the first and second guide track channels. The CAMs of the CAM sections continue to rotate in the second direction independently, simultaneously and at the same or different speeds and thus a dynamic multi axis helix motion of the second surface is typically achieved but not limited to that motion.

In both cases any combination of CAM movements are able to be completed for the first or second surface including the pure vertical lifting of each, as well as pitching and rolling and surface yaw. The extension shafts of the CAMs allowing the surfaces to engage with the CAMs yet not limit the profile of the CAMs and therefore not limit the motion of each surface. Each surface moves respective to the at least one CAM profile.

In this embodiment the orientation of the CAM sections is shown where each opposing CAM section does not have the same orientation. With reference to FIG. 3, this results in each of the guide tracks respective to the CAM sections also having a different orientation. Typically but not limited to CAM sections 41A and 41C are not in the same orientation as the CAM sections 41D and 41B are not in the orientation. However, it will be appreciated that different orientations of the CAM sections both overall and with reference to each opposing CAM section are able to be used.

The CAMs via the extension shaft engage with the at least one first or second guide track via the first or second channel. Respective to which of the surfaces is being moved by the CAMs, the surface is held such that any unwanted movement is eliminated by the orientation of the at least one first and second guide track. For example, the front to rear orientation of the CAM sections 41C and 41B ensure that the surface is unable to feature any unwanted right to left (side to side) movement whereas the orientation of the sections 41A and 41D ensure that the surface is unable to feature any unwanted front to rear (back and forth) movement. Any unwanted movement is inhibited as the orientation of the respective guide track and its engagement with the respective CAM places an unwanted movement and the force thereof against the CAM and as such the CAM will resist and inhibit any unwanted movement via its relationship with both the respective at least one guide track and the respective CAM section.

As will be appreciate the CAM in the section 41A, 41B, 41C and 41D is able to have all the same functions and features as the CAMs 44A and 44B referenced in FIGS. 4A and 4B respectively. The functions and features include the ability of the CAM to pivot about its axis and as has been described previously the extension shaft of the CAM is able to pivot independently in at least one axis.

The orientation of the at least one guide track is not only respective to unwanted movement described above, but also respective to wanted movement of the respective surface. As an example and with reference to but not limited to the opposing CAM sections 41A and 41C, if the first surface was a distance away from the surface zero point resultant from the CAMs of all the sections rotating in the first direction, when all CAMs are stationary and the section 41A starts to rotate its CAM in the first direction then the surface would want to pivot about the CAM of the section 41C. As such the fourth edge of the surface would lift and the at least one first guide track respective to the CAM of section 41C would induce an axially rotation of the CAM in 41C and as such the CAM becomes a live pivot point. The pivot point of the CAM is with reference to that discussed specifically in FIG. 4A.

It is further apparent that should the CAM from the section 41C move in the first or second direction the respective angle of surface respective to the CAM profile and position of the CAM from section 41A, then the surface angle could be increased, decreased or maintained respective to the motion of the CAM from section 41A. It will be appreciated that the extension shaft of the section 41C CAM may also pivot about its pivot point respective to both the orientation of the CAM and the motion of the surface. This pivotal ability allows the at least one roller and or bearing of the section 41C CAM to remain in contact with the surface. It will be appreciated that the above is able to be applied to any opposing or non-opposing CAMs and their relative sections and respective to any motions of the respective surface.

It will be furthermore appreciated that the CAMs from any other section are able to contribute to any movement both in terms of wanted surface movement and or unwanted surface movement. With relation to the above description, as the CAM from the section 41A operates and the surface pivots about the CAM in section 41C, the CAMs from sections 41B and 41D are also able to contribute to the surfaces movement and retention.

Firstly the CAMs from sections 41B and 41D are able to rotate typically in the first direction and contribute additional force and motion for the movement of the surface and furthermore the orientation of the CAM section 41B and 41D and therefore the orientation of the at last one guide track and CAMs thereof mean that any unwanted movement via the respective guide tracks and especially with relation to the CAM section 41B will be inhibited any unwanted movement. It will be further appreciated that the CAMs of the sections 41D and 41B are able to axially pivot via the employment of functions and features from the aforementioned CAM 44A from FIG. 4A.

With relation at least one CAM of at least one CAM section of the second embodiment is able to have any function or feature of the CAM 44, CAM 44A and CAM 44B from FIGS. 3, 4A and 4B. It will be appreciated that the CAMs in this embodiment are therefore able to change length and profile additionally to the ability to rotate in the first or second direction. The ability to change profile is both with respect to the extension and retraction capability described in FIG. 4A and with respect to the load placed on the CAM as described with relation to FIG. 4B.

As such the at least one CAM length in the second embodiment is able to change with both load and through actuation where the former changes the length of the at least one CAM proportionally and or disproportionally respective to the magnitude of load as well as the speed at which a load is applied to the at least one CAM.

Furthermore, as the length of the at least one CAM is able to change, the at least one profile of the CAM is able to change through the actuation of the CAM and or respective to the magnitude of load and the speed at which the load is applied to the at least one CAM. In all cases the length of the CAM and its ability and rate of change is able to be proportional and or disproportional to at least one other CAM within the second embodiment as well as the magnitude of load, the speed of the loads application and direction the load is acting with respect to at least one CAM.

In this embodiment the orientation of the at least one CAM section and therefore the at least one CAM and at least one guide track shows that no element 128 or associated components are required and as such this embodiment will produce a pure form of the dynamic multi axis helix motion. This second embodiment is the truest form of floating surface and has many applications such as the surface being able to be used and incorporated into seats for babies, children and adults and or beds and or incubators for domestic and medical or automotive applications. For beds the surfaces are able to be incorporated into a bed frame and used to support the patient as a type of moveable mattress and in both cases multiple surfaces are able to combine to form an individually or simultaneously moveable surface. Other applications include armour, outer bodies of vehicles such as ships, cars or tanks and aeroplanes or helicopters as well as for solar panels and hydrofoils mainly respective to renewable energy. Other applications include such items as a workbench or to place underneath an object to level that object.

The first and second embodiments are able to achieve gyroscopic self levelling whereby the motion of a body in which they are placed is countered by the movement of the CAMs in the first and second body. In this manner the first or second surface is able to be kept level or keep its position respective to the motion of the body in which the embodiments are placed. As an example, if the first or second embodiment was placed on a ship, as the ship pitched and rolled the first or second surface would be able to maintain a levelled position as if the ship were stationary. The same capability is able to be used with relation to occupant seating in a vehicle or a baby seat for vehicle, where as the vehicle moved the CAMs would rotate in the first or second direction and maintain the position of the respective surface as if the vehicle where stationary.

A further example of the first and second embodiment is typically specific to seating in a vehicle for land, sea or air. Typically it is most apparent with relation to land based vehicles and in particular but not limited to cars, vans trucks and buses. In the unfortunate event of an impact, the occupants of such transport are known to undergo high forces. Typically occupants are not in the correct position to gain optimum support and absorption from their seating which is able to lead to increased injury from an impact.

However, the first and second embodiment with respect to the usage of at least one CAM 44B is able to increase the support offered to the occupant and reduce excess injury. If the first surface becomes the surface of a seat and the second surface is attached the chassis of a vehicle, then as an impact occurs and from any angle the occupant of an impacted vehicle will receive forces from the impact. The occupant is unlikely to be correctly positioned correctly in the seat with typically loading to one side of the seat or in this case first surface. In an impact the occupant is able to move away from the seat and then into the seat or simply into the seat. This means that the load on the seat and thus the first surface will change. If the occupant moves away from the seat and thus the first surface, then the CAM springs described in FIG. 4B will allow the first surface to move with them respective to the characteristics and properties of the CAM springs and the at least one valve.

For the first embodiment and assuming the drivers seat in a right hand drive vehicle, the CAMs respective to CAM sections 40C and 40D and for the second embodiment the at least one CAM from CAM section 41C will typically feature two valves on the first chamber, whilst the CAMs in the sections 40A and 40B and 41A will feature just one valve in the first chamber.

As such as the occupant moves forward, the first surface and therefore the seat will move with them as a result of and with reference to FIGS. 4A and 4B the at least one CAM spring 104 and 84. The surface and therefore seat with a slight bias to the sections 41C, 40C and 40D movements as the occupant will encounter the action of seat belt which will slight bias them. As the occupant becomes stationary they will then begin to move back into the seat and thus the first surface. As this movement occurs, the extra valve in the first chamber on the section 41C, 40C and 40D will see the occupant move into the seat with a slight bias to correct the bias from the forward motion. With reference to FIG. 4B, as the piston head 100 moves further down the first chamber the second valve of the first chamber will be past and thus the CAMs from section 41C, 40C and 40D will move at the same rate in the second direction of linear travel as the CAMs from section 40A, 40B and 41A and as such the occupant will be centred in the seat and therefore the surface and in the optimum position for safety and support.

The at least one CAM spring characteristics and properties as well as the at least one valves characteristics and the properties are able to be harmonised and used in any combination on any CAM or CAMs to give the required response to impact. It will be appreciated that many combinations of valve and spring arrangements for the CAM are able to be achieved with many different surface and therefore seat movement resultants. It will also be appreciated that such responses are able to be used as a form of seat type suspension.

FIG. 5C shows the third embodiment 123 which is able to have all the same functions and features as the first two embodiments and has the ability to produce a dynamic multi axis helix motion in two surfaces at the same time. The CAM sections 43A, 43B, 43C, 43D, 43E, 43F and 43G are able to have all the same functions and features as CAM sections 41A, 41B, 41C and 41D as well as the CAM section 40A, 40B, 40C and 40D in FIGS. 5A and 5B respectively and the CAM section 40 described in FIG. 3 and where the features and functions are the same they will not be described in detail as they have been described previously.

The first surface 127 is able to have all the same functions and features as any referenced first surface herein and the first surface 124 and 125 as described in the first and second embodiment. The second surface 135 is able to have all the same functions and features as any referenced second surface herein and the second surface 132 and 133 and as described in the first embodiment.

The at least one CAM in each CAM section 43A through to 43G is able to have all the same functions and features as the CAM 44 from FIG. 3 as well as all the same functions and features of the CAMs 44A and 44B from FIGS. 4A and 4B respectively. This embodiment has eight CAM sections and typically but not limited to not each CAM section in the embodiment does not feature any locking elements. Each CAM section is permanently or removably attached to or integrated with all the other CAM sections to form a CAM chassis.

Each CAM section is able to rotate it's at least one CAM in the first or second direction as was described in the second embodiment whereby each CAM will engage with either the first or second guide track via the CAM extension shaft and the respective guide track channel. In this embodiment it is typical that four CAM sections rotate their CAMs in the first direction and four CAM section rotate their CAMs in the second direction. As described above the CAMs are initially positioned at the CAM zero position where the surfaces and thus guide tracks are also at their respective zero positions. Four CAM sections will rotate their CAMs in the first direction and four CAM section will then rotate their CAMs in the second direction and as such the first and second surface will move away from each other.

As has been described, as the respective CAMs rotate they will move from the zero position into the first or second guide track 50 (see FIG. 3) and as such engage with the respective surfaces. Each of the of CAMs as all other embodiments is able to rotate independently or simultaneously with at least one other CAM and each CAM is able to rotate at the same speed or a different speed to at least one the CAM and furthermore each CAM is able to change its profile respective to load characteristics and or actuation.

Therefore the third embodiment is able to produce the multi axis dynamic helix motion in both the first and second surface and as such the CAM chassis becomes a floating CAM chassis whereby the CAMs rotational axis is able to vary with respect to both the first and second surface. The third embodiment allows the gyroscopic self levelling of two surfaces respective two different inputs.

As an example of usage and as described above the embodiment can be located with a body such as a ship. As such the second surface is able to be attached to the body whereby the CAM chassis is able to be a distance away from the second surface with the lower four CAMs engaged with the second surface. As the ship moves, the lower CAMs dynamically adjust to gyroscopically self level the CAM chassis respective to the ships motion. By contrast the first surface is a distance away from the CAM chassis with the upper four CAMs engaged with the first surface. Therefore the upper four CAMs via the dynamically levelled CAM chassis have a levelled based from which to rotate and impart a motion such as the dynamic multi axis helix motion on the first surface irrespective to the motion of the ship or other vehicle or body.

FIG. 6 illustrates a rotary actuator 140, in this case but not limited to the rotary actuator is the applicant's own proprietary gearbox described in the Applicant's co-pending International patent application number PCT/GB2010/000250, however any other suitable rotary actuators are able to be used.

The rotary actuator is a self contained unit with a casing 150 and at least one component therein. The rotary actuator in this case typically includes at least one actuator 142 which is typically an electric motor which is attached to the leadscrew 146. The leadscrew is held by at least one bearing and in this case two bearings, 144 and 152. The leadscrew is further able to feature an external drive ability via the shaft extension 156 which is attached or integrated with the leadscrew 146 and held via the bearing 154. The rack nut 148 is meshed with the leadscrew 146 and via the toothed section is meshed with the gear 162. Typically the gear 162 is on the same shaft as the gear 164. The gear 164 like any other gear is able to feature a spring system which in this case but not limited to uses at least one tine or other spring element 166 to connect to an inner ring 160 and an outer ring 168.

The gear 164 is meshed with the gear 170 which is in turn meshed with the gear 172. The gear 172 is attached to the exit shaft 180. The gear is attached via node 174 to the spring 176 which is in turn attached to the node 178 whereby 178 is attached to the casing. Typically the motor 142 rotates in the first or second direction, which in turn rotates the leadscrew in the first or second direction. The meshed relationship the nut 148 has with the leadscrew moves the nut along the axis of the leadscrew in the first or second direction resultant from the rotation of the motor and subsequent leadscrew. The linear movement of the nut linearly moves the toothed section 158 which rotates the gear 162 to which it is meshed. The rotation of the gear 162 rotates the gear 164 which in turn rotates the gear 170 which in turn rotates the gear 172 and the output shaft 180 in either the first or second direction depending on the rotational direction of the motor as described.

The shaft extension 156 is able to be connected to an external rotary actuator such as a manual handle or an electric motor and typically these are able to be used to boost the rotational capability of the drive or if the drive fails such as the motor 142 and the output shaft has a requirement to rotate.

The spring in the elements 168, 166 and 160 combine to form a sprung member. The at least one sprung member has an inner ring 160 attached to the gear 162 shaft or casing whilst the outer 168 is attached to the outer gear 164 or the casing. In the first instance with the inner ring 160 connected to the shaft on which both gears are located, the shaft is able to be stationary within the casing with the gears located on the shaft on at least one bearing and the outer ring 168 attached to the gear 164. Therefore as the gear 162 and 164 rotate the elements 166 store from energy from rotational motion of the gear 164 and 162 or release energy into the gear 164 as rotational force and therefore motion. In the second instance, if the gears 162 and 164 are integrated or otherwise rigidly held on the shaft and the shaft rotates, then the inner ring 160 will be attached to and held stationary by the casing and therefore and as before the elements will store or release rotational force into the gear 164.

The spring element 176 operates in a similar manner to the above whereby the as the gear 172 rotates the spring 176 stores energy and as the gear 172 rotates in the opposite direction the spring releases the energy as force on the gear 172 to assist rotation. In both cases with regards to both sprung means concerning the components 176 and 168, 166 and 160 they are able to be applied to any gear and able to be harmonised to work together as well as for the reduction of backlash and for the optimisation of gear wear.

The sprung means is also able to be used with or without an electric motor or other actuator 142 and furthermore they are able to allow the shaft to be held at a pre-set and adjustable tension such the output shaft is able to be used as a suspension like unit.

Although not shown it is possible for the toothed section 158 to be disconnected from the gear 162 and thus allow free wheel of the gear 162. This is accomplished via the addition of a bar which runs through the section 158 where section 158 is movably attached to the nut 148. At least one linear actuator is placed at one end of the bar such that activation of the actuator lifts the bar which in turn lifts the section 158 whereby the linear actuator is able to be retracted and lower the bar and as such the toothed section 138 back into a meshed relationship with the gear 142.

FIG. 7 illustrates a second type of CAM section 190. The figure shows the CAM section 190 having a gearbox 140, however any suitable gearbox or rotary actuator are able to be used. The CAM section 190 also features at least one CAM 192 and or 194 which are permanently or removably attached to or integrated with the gearbox via the exit shaft of the gearbox 180 (as described in FIG. 6) and the joining component 196 where the joining component 196 is able to be pivotally, permanently or removably attach to or integrated with the at least one CAM.

The CAM section 190 is able to have all the same functions and features as the CAM section 40 from FIG. 3 where appropriate. The CAMs 192 and 194 are able to have all the same functions and features as the CAMs 44, 44A and 44B in reference to FIGS. 3, 4A and 4B respectively. In this case the CAMs are respective to CAM 44A from FIG. 4A where the CAMs incorporate at least one linear actuator 16 (see FIG. 2). The linear actuator 16 in the case of the CAM 194 has two motors 21 (respective to FIG. 2) whereas CAM 192 features just one motor 21.

The figure illustrates three variations of CAM section 190, the first type with at least one gearbox or rotary actuator and at least one CAM 192, the second with at least one gearbox or rotary actuator and at least one CAM 194 and the third with at least one gearbox or rotary actuator and at least two CAMs 192 and or CAM 194.

As will be appreciated with respect to the above the at least one CAM is rotated by the gearbox or rotary actuator in either the first or second direction. Also as previously described, the CAMs 192 and 194 with the presence of linear actuators are able to extend and retract linearly respective to the activation of the piston which is described in FIG. 4A.

FIG. 8 illustrates the CAM nest 198 in plan view which features at least one CAM section 190. Typically the CAM nest features four CAM sections 190A, 190B, 190C and 190D arranged in an orientation generally similar to the one illustrated where each CAM section has the seem functions and features as CAM section 190. With reference to FIG. 7, each CAM section is able to both rotate the at least one CAM in the first or second direction independently or simultaneously or at the same or different speeds respective to at least one other CAM section and each CAM is able to extend or retract independent of or simultaneously respective to at least one other CAM and at the same or different speeds.

It will also be appreciated that the CAMs section are able to be non-connected as shown and it will also be appreciated that the CAM nest can have all the same functions and features as the third embodiment in FIG. 5C. With respect to the third embodiment any connection between at least one CAM section and at least one other is able to be either flexible with at least one pivot featuring at least one axis or rigid.

FIGS. 9A, 9B and 9C illustrates the fourth embodiment of the CAM surface 200. The fourth embodiment is able to have all the same functions and features as the first, second and third embodiments where appropriate. It will be appreciated that where features and functions are the same, the description of those functions and features will not be repeated.

The CAM nest 198 is located between two surfaces 203 and 205. The first surface 203 and the second surface 205 are able to have all the same functions and features as has been described of the any first or second surfaces. In particular the first surface 203 is able to feature all the same functions and features as the first surfaces 124, 125 and 127 whilst the second surface 205 is able to feature all the same functions and features as the second surfaces 132, 133 and 135.

As has described previously the at least one CAM sections 190A, 190B, 190C and 190D of the CAM nest 198 are able to have all the same functions and features as has been described with relation to CAM section 190 (see FIG. 7) and CAM section 40 (see FIG. 3) and with relation to the CAMs 44, 44A and 44B from FIGS. 3, 4A and 4B respectively as well as CAMs 192 and 194 (see FIG. 7) where appropriate. It will be appreciated that like other CAMs sections described in the patent, the at least one CAM section 190A, 190B, 190C and 190D that make up the CAM nest, will feature dual linear actuating CAMs 192 and or 194 (seen in FIG. 7) with reference to the CAM section 190. It will be appreciated that the CAM 192 is able to have all the same functions and features as CAM 194 and CAM 194 is able to have all the same functions and features as CAM 192.

The CAMs 192 and 194 feature an extension shaft which has been described previously respective to FIG. 3. The extensions shafts protrude from the CAMs and engage with a first and second channel in the first and second guide track. Therefore the CAM 192 (seen in FIG. 7) engages with the first guide track of the first surface 202 and the CAM 194 (seen in FIG. 7) engages with the second guide track of the second surface 204.

It will be appreciated that the CAM 192 is able to have all the same functions and features as CAM 194 and the CAM 194 is able to have all the same functions and features as CAM 192.

As has also been described, the CAMs 192 and 194 are able to feature rollers and or bearings, where the roller and or bearing of the CAM 192 contact the first surface and the bearings and or rollers of the CAM 194 contact the second surface. The surfaces typically not limited to feature a profile where the roller and or bearing contact the respective surface.

With reference to 9A, it will be observed that the at least one CAM section 190A, 190B, 190C and 190D in the nest 198 are rotated such the first and second surface are close together with the at least one CAM section from the CAM nest 198 and the surfaces are at their respective zero point. The CAM sections are paired, where CAM sections 190A and 190D are a pair and CAM sections 190B and 190C are a pair. Both CAM pairs counter rotate with respect to the other CAM in the pair. Therefore the 190A rotates clockwise in the first direction whilst 190B rotates anti-clockwise in the first direction and 190B rotates clockwise in the first direction whilst 190C rotates anti-clockwise in the first direction. It will be appreciate that in the second direction the counter rotating means will be reversed and that the clockwise and anti-clockwise nature of the movement is able to be exchanged between the CAM sections in the pair.

9B illustrated that as the at least one CAM sections rotates in the first direction the at least one CAM in the first and as such the first surface moves away from the second surface. FIG. 9C shows the continued rotation of the at least one CAM will result in the first surface moving to the maximum CAM rotational distance from the second surface.

It will also be appreciated that as the CAMs rotate the CAMs rotational axis moves relative to the CAMs rotation and as such is a floating CAM axis. At any point before, during or after the rotational cycle the at least one CAM is able to be extended or retracted and as such the first and second surface are able to move further apart or closure together without any CAM rotation. CAM sections are able to rotate the CAMs simultaneously or independently at the same or different speeds and or different directions and the CAMs are able to extend and retract independently or simultaneously at the same or different speeds and or directions and as such the first and or second surface are able to achieve a dynamic multi axis helix motion simultaneously or independently of each other and at the same or different speeds and or directions with no sequencing.

FIGS. 10A and 10B illustrate a connection assembly 239 which can be used on any embodiment in whole or in part. The figure shows the first and second surface 231 and 233 where the first surface 231 and the second surface 233 are able to have all the same functions and features as has been described of the any first or second surfaces. In particular the first surface 203 is able to feature all the same functions and features as the first surfaces 124, 125, 127 and 203 whilst the second surface 205 is able to feature all the same functions and features as the second surfaces 132, 133, 135 and 205. The CAM section 235 is able to have all the functions and features of the CAM section 40 and 190 as described respective to FIG. 3 and FIG. 7 and the at least one CAM 237A and 237B is able to have the functions and features of the CAMs 40, 44A, 44B as well as 192 and 194 from FIGS. 3, 4A, 4B and FIG. 7. It will be appreciated that where features and functions are the same, the description of those functions and features will not be repeated.

The assembly 239 allows a free movement of any CAM or any CAM section with respective to the profile of the at least one CAM, the rotational direction of the at least one CAM and the load placed on the at least one CAM.

FIG. 10A illustrates that the at least one CAM section 235 connected to the CAM 237A which interacts with the first surface such that rotation of the section 235 will rotate the CAM 237A and move the first surface. The CAM 237A interacts with the first surface 231 via a pivot connection 202 which pivotally connects the CAM with the shaft 204. At the end of the shaft 204 is a permanently or removably attach or integrated end cap 206.

The shaft 204 features at least one the roller and or bearing 208 where the roller and or bearing is able to feature a crowned outer surface. The shaft 204 passes though a profiled or non-profiled channel 210 located in the pivot track 212. A both sides of the track are sliders 214 and 222 which are able to pivot and slide linearly on the shaft 204 due to the shaft slot 216 and each slider having a slider pin 218. The at least one pivot track 212 is pivotally connected to the first surface via a pivot 220. Typically the roller and or bearing 208 is located in a channel created by the raised profile sections in the first surface, the raised profile sections are as illustrated 224 and 226. The raised profile 226 forms a channel in which the pivot track 212 operates with the addition of the further raised section 228.

FIG. 10B illustrates that the at least one CAM section 235 connected to the CAM 237B which interacts with the second surface such that rotation of the section 235 will rotate the CAM 237B and move the second surface. It will be appreciated that the interaction of the CAM 237B is the same as 237A with all the same features and functions and so the description will not be repeated. However the CAM 237B features one difference, that of the multi-axis pivot connection 230 which is an additional pivot connection which permanently or removably is attached to or integrated with the shaft 204 and the CAM 237B. It will be further appreciated that the pivot 230 is also able to be utilised with respect the CAM 237A as discussed respective to FIG. 10A.

FIG. 10A and FIG. 10B are able to be applied separately or jointly, for example, FIG. 10A would generally be used respective to the first, second and third embodiments whereas FIG. 10A and FIG. 10B would be generally utilised respective to the fourth embodiment. For the purpose of the description a double CAM section such as that described in FIG. 7 with a usage will be detailed as will an overall assembly such as of the fourth embodiment as described in FIGS. 8 and 9A, 9B and 9C.

Relating to both FIGS. 10A and 10B, the at least one CAM section 235 has two CAMs 237A and 237B which interact with the first and second surface as described. The at least one assembly 239 is able to retain the first and second surface securely yet allow the at least one CAM section 235 to perform the dynamic multi-axis helix motion without sequence. Using the fourth embodiment for the example, four CAM sections 235 are orientated respective to FIG. 8 with each featuring two CAMs 237A and 237B. In the first movement, the at least one CAM section 235 rotates the CAMs 237A and 237B in the first direction. As the CAMs rotate the roller and or bearing 208 respective to the first surface and second surface will move along the channel created by the profiled sections 224 and 226. This movement will also move the shaft along the channel 210 in the pivoted track 212.

As the CAM sections rotate the first surface 231 will be lifted and moved away from the second surface 233 in a level manner assuming all CAMs are being rotated simultaneously and at the same speed and profile. Once this first movement has been completed and the CAMs have stopped rotating, the first surface will be level and a distance away from the second surface. In the second movement only one CAM section rotates its CAMs whilst the others are stationary. It will be appreciated that where the CAMs 237A and 237B include actuators respective to the CAM 44A in FIG. 4A the second movement is also able to be an extension of the at least one CAM of the first CAM section.

This second movement will tilt the first surface where the second CAM section will remain geometrically unchanged in terms of its CAM rotational position and CAM extension and retraction, yet the third and fourth CAM sections which directly adjacent to the first CAM but opposite each other will change geometrically and as such the first surface will pivot on the two CAMs of third and fourth CAM section.

The first tilting in this manner means that the shaft 204 respective to the first and second CAM sections will change its angular relationship with the respective CAMs and pivot about the respective pivot point 202. This pivoting causes the track 212 to pivot about 220 which in turn both pivots and linearly moves the sliders 214 and 222 about their pivot pins 218 and slot 216 where this described occurrence in the assembly is with respect to the CAMs 237A and 237B of the first and second CAM sections. It will be appreciated that the profiled channel in which the track 212 operates gives the track and therefore the first and second surface a maximum tilt angle, however, the channel is able to be widened and or reduced respective to requirement. It will be both appreciated that other movements from any of the four CAMs are able to be dealt with by the arrangement and that the arrangement is able to be used on the first, second or third embodiments in whole or in part as well as respective to the fourth embodiment as described above.

FIG. 11 illustrates the plan view of a modular CAM base 240 on which any embodiment such as the first 120, second 121, third 123 or fourth 200 are able to be permanently or removably and or movably attached to or integrated. In this case the Figure illustrates the fifth embodiment of the CAM assembly.

For the sake of clarity, the reference 256 is an illustration of any of the embodiments 120, 121, 123 and 200. The base 240 consists of at least one CAM section situated in a horizontal position. In this case the base has at least one CAM sections and typically four CAM sections. Each Cam section 252A, 252B, 252C and 252D has a rotary actuator or gearbox 140 seen in FIG. 6 or any other suitable rotary actuator or gearbox. The CAM sections are able to be permanently or removably attached to or integrated with the base 254.

The CAM sections feature at least one CAM 244, 246, 248 and 250 respectively and the each CAM is able to have the same function and features as the CAM 44, 44A and 44B where appropriate. As is illustrated by the figure the CAMs include a linear actuator 16 as seen in FIG. 2 with the exception that the motor 21 (from the same figure) is inline with the leadscrew 32 (see FIG. 2). The CAMs further have outriggers 242A, 242B, 242C and 242D which are linear actuators seen FIG. 2 and orientated in this case generally perpendicular to the longitudinal CAM axis.

The CAMs are permanently or removably attached to or integrated with the rotary actuator or gearbox of the CAM section such that when the CAM section operates the gearbox or rotary actuator the respective CAM is able to rotate in the first or second direction. As has been described previously the CAM overall length and therefore profile is able to be geometrically altered such that the length will decrease or increase respective to the retraction or extension of the at least one linear actuator 16 in the respective CAM.

It will be appreciated that each CAM is able to feature at least one roller and or bearing and or wheel and typically these are perpendicular to the axis of the CAM as well as being able to be generally inline with the axis of the CAM as described previously. Within the base casing is a fifth rotary actuator or gearbox 252E which is able to have all the functions and features of the gearbox 140 in FIG. 6 or any other suitable rotary actuator or gearbox. The rotation of the rotary actuator 252E will rotate the permanently or removably attach or integrated embodiment 256.

As such this fifth embodiment is able to operate the CAM sections independently or simultaneously and at different or the same speed in the first or second direction and as such is able to rotate the CAMs in the same manner. The CAMs are able to extended and retract via the linear actuators they contain. Furthermore the outriggers are able to extend and retract and as such lower and raise the base respective to the rotational position and the profile (length) of the CAM.

The fifth embodiment is able to perform a dynamic multi-axis helix motion akin to the other embodiments. This helix motion is able to occur as a function of both the rotation and extension or retraction of the CAMs as well as the extension and retraction of the outriggers. It will be clear that the outriggers once extended are able to raise their respective CAM and the distance between the outrigger and the base 254 centre will depict the amount the base will raise which is generally centred on the as rotational axis of the rotary actuator of the respective CAM.

It will be further appreciated that the rotational position of the CAM respective to at least one other CAM and respective to the extension of their outriggers will also effective the base generally respective to each CAM rotary actuator axis or rotation. Therefore if each CAM is rotated in the first or second direction and each outrigger is extended or retracted simultaneously or independently at the same or different speeds then the surface of the base is able to both raise vertically and in a levelled or in an uneven manner and or performs a dynamic multi-axis helix motion. Therefore if the base 240 is used to mount a device such as a hoist or digger or crane or gun turret, chair or a bed or bed surface with or without the first or second embodiments then the base 240 via the movement of the CAMs and outriggers is able to move the mounted item in a dynamic multi-axis helix motion.

It will be apparent that allows the base to provide a static or dynamic level surface even if the unit is placed on an uneven surface or moving surface. It will also be apparent that the base is able to counter any uneven loads or off centre loads or movements of a device or embodiment 256 that is placed upon it and thus provide a dynamically stable platform.

It will be further appreciated that the base is gyroscopic and self levelling and able to be used in any orientation whereby rollers and or bearings and or wheels either perpendicular to the axis of the CAMs or inline with the axis of the CAMs the base is able to be used horizontally or vertically. The ability to be able to be used in different orientations and have different orientations of wheels and or rollers and or bearings allows the fifth CAM surface embodiment to run on or in tracks or rails and with the additional ability to extend the CAMs means that the base 240 is able to able run against walls away from the ground and without support where the said rollers and the like are pushed into the walls by the linear actuators in the legs sufficient to allow the base to keep its vertical position.

It will be further appreciated that the any of the wheels and or rollers and or bearings are able to be self propelling and self steering in that they are able to provide drive, variable resistance to movement as well as and powered steering to the base.

All the embodiments and 240 are not just limited to the applications above, all the embodiments and 240 are able to be used for a wide variety of applications. All embodiments and 240 are able to be used as or in conjunction with a robot and or robot limb, renewably energy device, fork truck or other industrial plant, beds, chairs, hoists, crane arcade machine or exercise machine, gun turret, diggers, armour, towing systems and or exercise limb or any other such applicable application or device.

1. A manoeuvrable platform comprising a planar base manoeuvrable by at least one cam operated lifting sub system positioned in relation to a back surface of the base, the or each lifting sub system comprising a cam blade arranged in a plane substantially parallel to that of the planar base section and operably connected to a cam drive in a casing, a first linear actuator operably connected to the cam drive casing and configured to provide linear displacement along a first axis, a second linear actuator operably connected to the cam drive casing and configured to provide linear displacement along a second axis and a pivoting means arranged for rotating the planar base.

2. A manoeuvrable platform as claimed in claim 1 comprising multiple cam operated lifting subsystems arranged around a pivot means.

3. A manoeuvrable platform as claimed in claim 2 four subsystems arranged around the pivoting means which comprises a rotary actuator.

4. A manoeuvrable platform wherein the first axis and second axis respectively of the first and second linear actuators are orthogonal to each other.

5. A manoeuvrable platform as claimed in claim 1 wherein the sub systems are secured to the platform.

6. A manoeuvrable platform as claimed in claim 1 wherein the subsystems are provided as an integral part of the platform.

7. A manoeuvrable platform as claimed in claim 1 wherein the cam operated subsystem(s) has the following construction;
a cam blade in a rotationally mounted arrangement with a cam shaft, the cam shaft bearing a circumferentially arranged toothed section meshing with a toothed section of a toothed rack whereby linear motion of the toothed rack in either one of two opposite directions translates to rotary motion of the cam shaft in one of two opposite directions dictated by the direction of linear motion of the toothed rack, the toothed rack extending from a threaded nut, the axis of the nut arranged in parallel with the linear axis of the toothed section, the nut meshing with a complementary thread of a leadscrew which is rotationally mounted but constrained from linear motion and a drive for driving the leadscrew to rotate in either one of two opposite directions and thereby bring about linear motion of the toothed rack, an extension shaft associated with the cam blade and a guide track incorporating a guide channel in which, during operation, the extension shaft is caused to travel whereby to adjust the separation between the cam blade and the back surface of the platform.

8. A manoeuvrable platform as claimed in claim 7 wherein the connection between the extension shaft and cam blade includes a multi axis joint.

9. A manoeuvrable platform as claimed in claim 7 wherein the extension shaft is rotatably mounted with respect to the cam blade plane.

10. A manoeuvrable platform as claimed in claim 9 wherein the rotatable mount is a roller which is arranged to interact with one or more additional rollers provided in the cam blade:

11. A manoeuvrable platform as claimed in claim 7 wherein the toothed rack extends linearly to operably engage with a second gear rotatably mounted on a separate shaft in parallel axial alignment with the cam shaft.

12. A manoeuvrable platform as claimed in claim 1 wherein in the subsystem(s), the linear actuator incorporates a resilient biasing means which serves to assist linear motion of the piston in one of the two directions.

13. A manoeuvrable platform as claimed in claim 12 wherein the resilient biasing means comprises a spring which is under tension when the piston is retracted and tends to urge the piston to travel so as to extend.

14. A manoeuvrable platform as claimed in claim 12 wherein resilient biasing means are provided at both ends of the piston.

15. A manoeuvrable platform as claimed in claim 12 wherein at a free end of the casing of the linear actuator there is provided an attachment aperture.

16. A manoeuvrable platform as claimed in claim 15 wherein the aperture receives the cam shaft which is rotatably mounted therein.

17. A manoeuvrable platform as claimed in claim 16 wherein the attachment aperture forms part of an attachment element which is rotatably mounted about the end of the linear actuator casing.

18. A manoeuvrable platform as claimed in claim 17 wherein the cam shaft and attachment element are rotatably mounted about two orthogonal axes.

19. A manoeuvrable platform as claimed in claim 12 wherein at an opposite end of the linear actuator, the emerging piston terminates in a roller.

20. A manoeuvrable platform as claimed in claim 12 wherein the linear actuator is pneumatically or hydraulically controlled and incorporates one or more valves in its casing for controlling the speed of passage of fluid into and/or out of the chamber.

21-42. (canceled)
